(19) United States
(12) Patent Application Publication
(10) Pub. No.: US 2010/0328140 A1
(43) Pub. Date: Dec. 30, 2010

(54) Video-Doppler-Radar Traffic Surveillance System

(76) Inventors: Lang Hong, Beavercreek, OH (US); Steven Siying Hong, Beavercreek, OH (US)

Correspondence Address: Lang Hong, 616 Brookmeade Ct., Beavercreek, OH, 45434, US

(21) Appl. No.: 12/266,227

(22) Filed: Nov. 6, 2008

(51) Int. Cl. G01S 13/58

(52) U.S. Cl. 342/55; 342/104

(57) ABSTRACT

This invention is related to a Video-Doppler-Radar Traffic Surveillance System comprising of multiple Doppler radars and video cameras, circuitry for processing radar and video signals, and data recording and displaying devices. Although the system is mainly designed for roadside traffic surveillance, it can be used in different applications, such as mounted on a host vehicle or on a UAV. The system will provide continuous surveillance of all incoming and leaving traffic.

### TECHNICAL FIELD

The invention relates to a video-Doppler-radar (Vidar) traffic surveillance system.

### BACKGROUND OF THE INVENTION

(1) Doppler Radar Based Traffic Surveillance Systems: A traditional radar based traffic surveillance system uses a Doppler radar for vehicle speed monitoring which measures a vehicle speed at line-of-sight (LOS). In FIG. 1, the speed of an approaching (or a leaving) vehicle is calculated in terms of Doppler frequency f_{D} by

$${v}_{t} = \frac{{f}_{D}}{K cos ( {φ}_{t} )} \qquad ( 1 )$$

where K is a Doppler frequency conversion constant. Although a Doppler radar based system has an advantage of a long detection range, there are several difficulties associated with the traditional radar based system, including (1) the Doppler radar beam angle is too large to precisely locate vehicles within the radar beam; (2) the angle between the vehicle moving direction and the LOS, φₜ, is unknown and therefore, needs to be small enough for a reasonable speed estimation accuracy; (3) since all velocity vectors on the equal-Doppler cone in FIG. 1 will generate a same speed, the Doppler radar cannot differentiate the vehicles with a same speed but different directions defined by the same equal-Doppler cone. Therefore, no precise target location information can be derived in a traditional Doppler radar based traffic surveillance system.

(2) Video Camera Based Traffic Surveillance Systems:

A video camera based traffic surveillance system uses a video camera to capture a traffic scene and relies on computer vision techniques to indirectly calculate vehicle speeds. Precise vehicle locations can be identified. However, since no direct speed measurements are available and the camera has a finite number of pixels, the video camera based traffic surveillance system can be used only in a short distance application.

This invention combines the both Doppler radar based system and the video based system into a unique traffic surveillance system to preserve the advantages of both systems and overcome the shortcomings of both systems.

### SUMMARY

A video-Doppler-radar (Vidar) traffic surveillance system to monitor traffic may include a first movable Doppler radar to generate a first radar beam along the direction of a first motion ray, a second movable Doppler radar to generate a second radar beam along the direction of a second motion ray, a third fixed Doppler radar to generate a third radar beam along a direction ray, a video camera to serve as an information fusion platform by intersecting the first and second radar motion rays with the camera virtual image plane, a data processing device to process Doppler radar and video information, a tracking device to continuously point the surveillance system to the moving vehicle, and a recording device to continuously record the complete information of the moving vehicle.

The surveillance system may register the first movable radar and the second movable radar with the video camera by locating the intersections of the first and second movable radar motion rays with the video camera virtual image plane.

The surveillance system may locate a moving vehicle on the virtual image plane by intersecting two Doppler circles on the virtual image plane.

The surveillance system may find 3D lines linking Doppler circle intersections to the moving vehicle.

The surveillance system may locate the moving vehicle in 3D space by using three 3D lines from three frames.

The surveillance system may establish moving vehicle models for forming the moving vehicle trajectory.

The surveillance system may find the moving vehicle speed by using Doppler signal from the fixed radar over three frames.

The surveillance system may find the complete vehicle state information, position and velocity, by jointly using three radars and video camera.

The surveillance system may track the moving vehicle by continuously pointing to the vehicle using the vehicle location on the virtual image plane.

The surveillance system may record the moving vehicle state information onto a recording device.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the speed measurement of an approaching vehicle and a leaving vehicle with a Doppler radar;

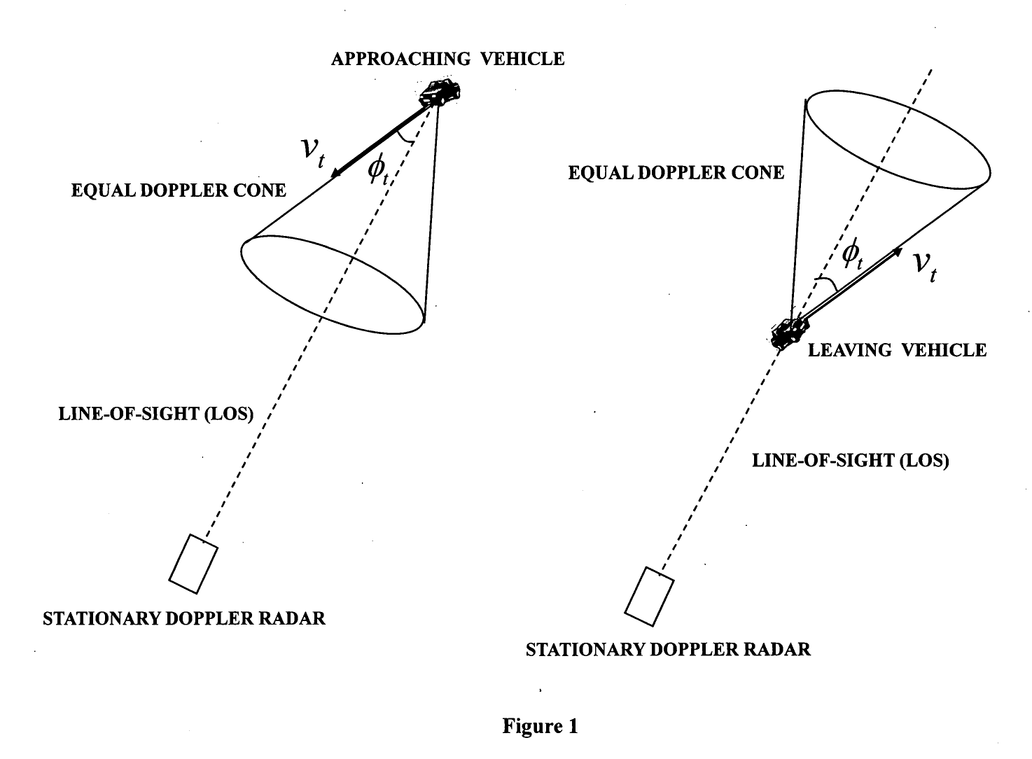

FIG. 2 illustrates the operational setup of the surveillance system;

FIG. 3 illustrates the lay out of the surveillance system;

FIG. 4 illustrates the functional flow chart of the surveillance system; and

FIG. 5 illustrates registration of the first and second movable Doppler radars with the video camera.

### DETAILED DESCRIPTION

While the term “traffic surveillance” is used herein, it may also refer to other traffic applications, such as “traffic monitoring”, etc. The term “video” may refer to “any image sequences” which may be generated by electro-optical or thermal or hyper-spectral devices. The invention discussed here may be applied to the case of multiple video cameras and more than three radars.

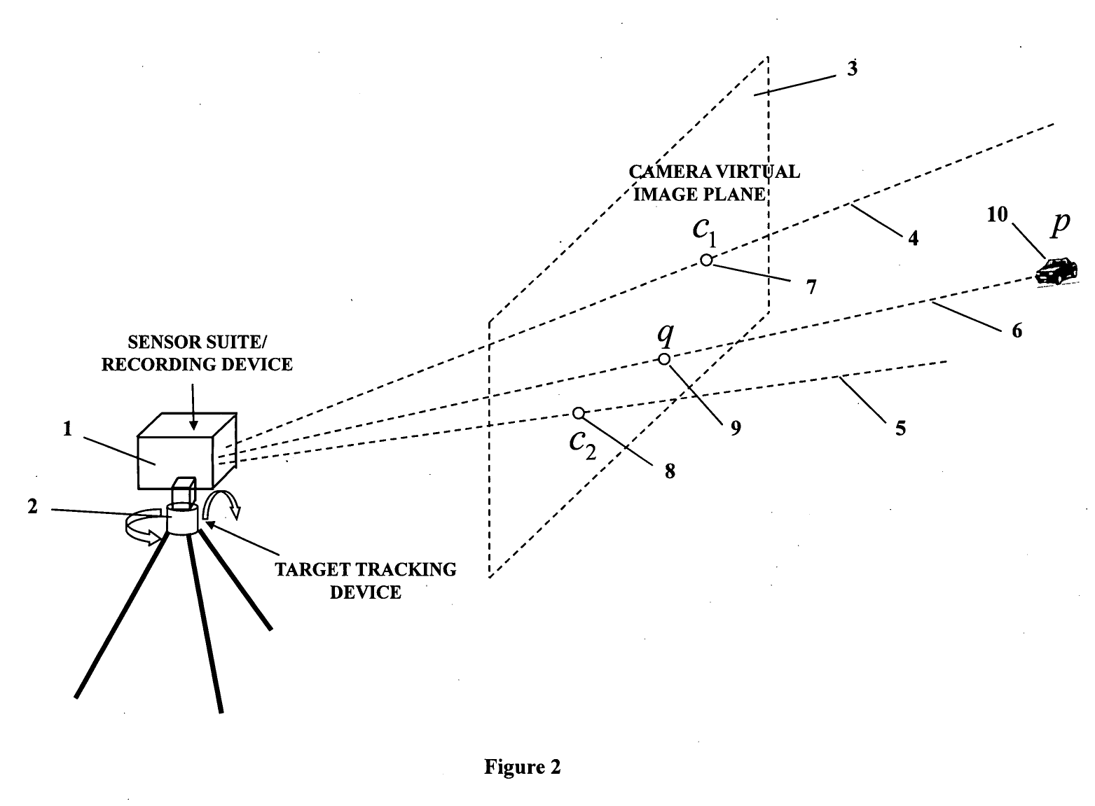

A video-Doppler-radar (Vidar) traffic surveillance system is shown in FIG. 2 where 1—the sensor system which may include a sensor suite/recording device or apparatus, 2—a target tracking device, 3—the camera virtual image plane of the video camera 14, 4—a first moving Doppler radar motion ray, 5—a second moving Doppler radar motion ray, 6—a radar direction ray connecting the sensor apparatus 1 to a moving vehicle 10, 7—the intersection of the first Doppler radar motion ray 4 with the virtual image plane 3, 8—the intersection of the second Doppler radar motion ray 5 with the virtual image plane 3, 9—the intersection of a ray connecting the sensor apparatus 1 and the moving vehicle 10, and 10 a moving vehicle.

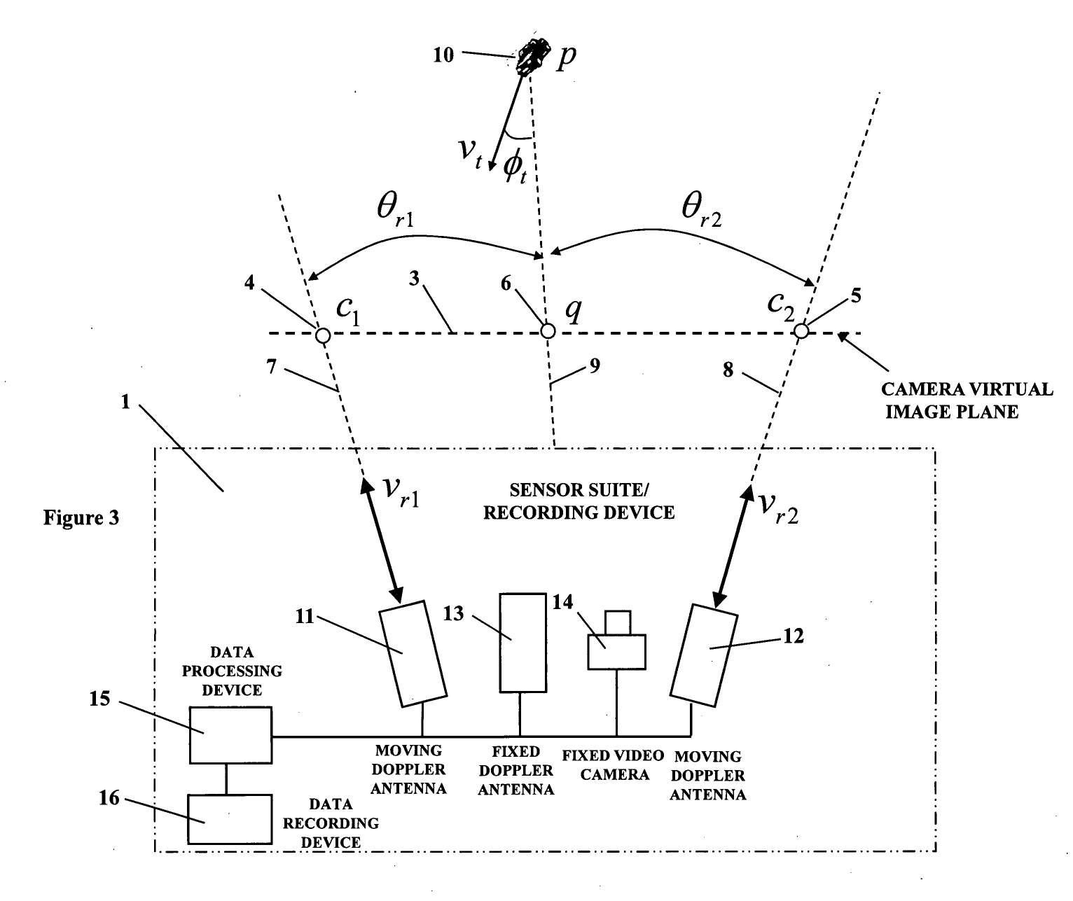

FIG. 3 shows the layout of the sensor apparatus 1 where 11—a first moving Doppler radar, 12—a second moving Doppler radar, 13—a fixed or stationary Doppler radar, 14—a fixed or stationary video camera, 15—a data processing device, such as a computer, laptop, personal computer, PDA or other such device, and 16—data recording device, such as a hard drive, a flash drive or other such device.

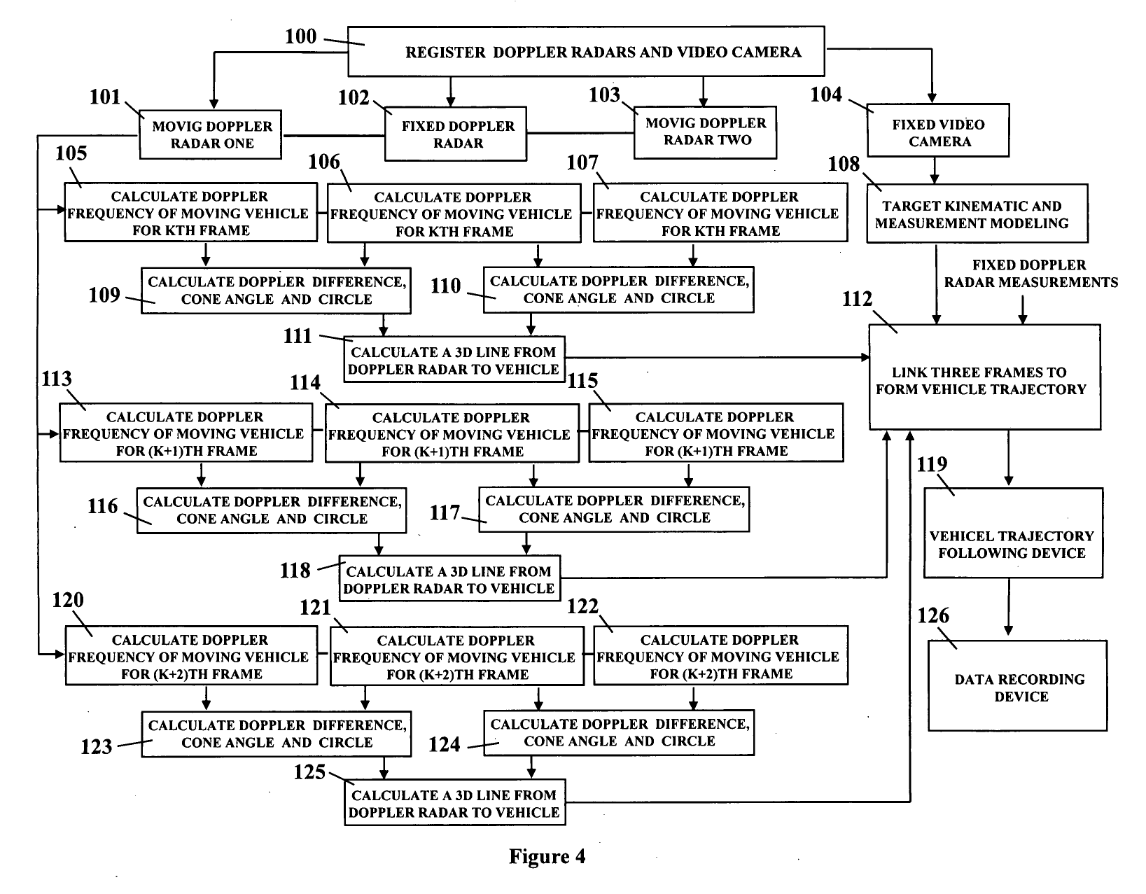

The functional flow chart of the system is shown in FIG. 4. In the following, we will describe the functional blocks.

1. Register Doppler Radars and Video Camera

The first and second Doppler radars 11,12 in the sensor apparatus 1 may be extended or retracted or moved side to side as illustrated in steps 100, 101, 103 by a motor (not shown) which may be a DC or stepper motor or other movement device and may be moved on sliding tracks (not shown). An optical encoder (not shown) may be mounted on the shaft of the motor, so the sliding speeds of the Doppler radars (νᵣ_{₁} and νᵣ_{₂} in FIG. 3) may be predetermined. The sliding track orientation angles (θᵣ_{₁} and θᵣ_{₂} in FIG. 3) may be predetermined. Using a calibration method, the intersections (C₁ and C₂ in FIG. 2) of the first and second motion rays 4, 5 with the virtual image planes 3 may be predetermined. Note, this registration method can be applied to a plurality of Doppler radars and cameras.

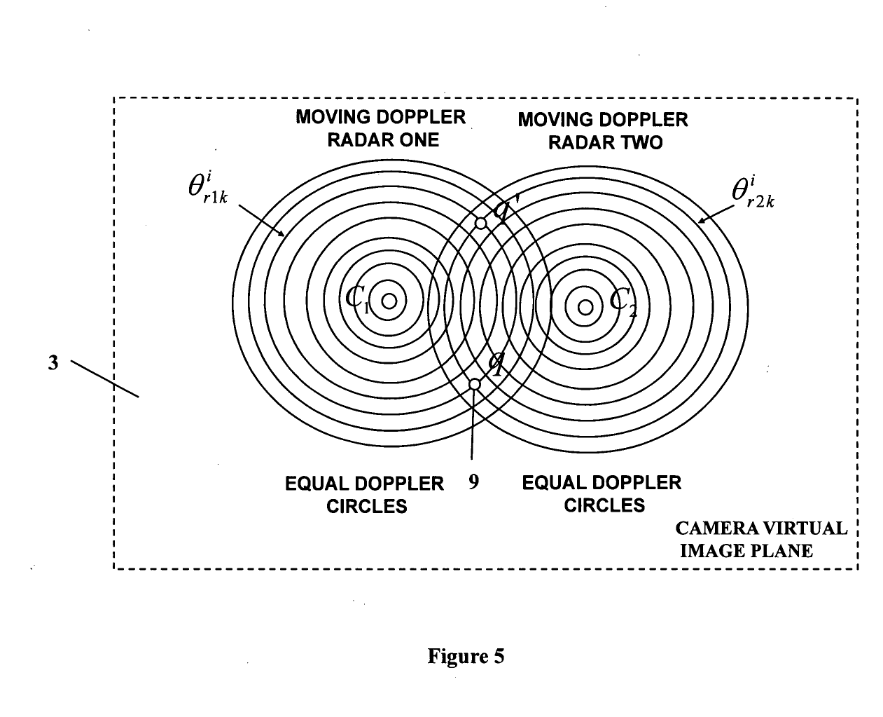

It can be seen in FIG. 5, showing the registration of the first and second moving Doppler radars 11, 12 with the video camera 14, with the determination of C₁ and C₂ that the first and second moving Doppler radars 11, 12 may be substantially precisely registered with the video camera 14. The locations of substantially equal-Doppler cones of each of the radars 11, 12 may be determined on the camera's virtual image plane 3, so that the physical information from the moving vehicle 10 may be calculated from both Doppler and video signals from the first moving radar 11, the second moving radar 12, a stationary Doppler radar 13 and the video camera 14. The computing device 15 may accept inputs from the above described elements and may perform the following calculations.

2. Calculate Doppler Frequency of the Moving Vehicle for the k th Frame

Assume the current time is the time of the k th video image frame, i.e., t=k in steps 105, 106, 107. The Doppler frequencies of the moving vehicle p 10 induced by both moving Doppler radars may be given by

f_{D}_{ₖ}¹=K₁[νₜ_{ₖ} cos(φₜ_{ₖ})+νᵣ_{₁ₖ} cos(θᵣ₁_{ₖ})] (4)

and

f_{D}_{ₖ}²=K₂[νₜ_{ₖ} cos(φₜ_{ₖ})+νᵣ_{₂ₖ} cos(θᵣ₂_{ₖ})]. (5)

where K₁ and K₂ may be Doppler conversion constants for the first and second moving Doppler radar (11 and 12 in FIG. 3), and θᵣ₁_{ₖ}, θᵣ₂_{ₖ} and φₜ_{ₖ} are depicted in FIG. 3 with an additional time index k. A fixed Doppler radar 13 may be used to sense the moving vehicle motion

f_{D}_{ₖ}³=K₃νₜ_{ₖ} cos(φₜ_{ₖ}) (6)

where K₃ is the Doppler conversion constant for the fixed Doppler radar (13 in FIG. 3). Doppler frequencies described by Eqs. (4), (5) and (6) may be obtained at (k+1)th and (k+2)th frames, as in steps 113, 114, 115, 120, 121, and 122.

3. Calculate Doppler Difference, Cone Angle and Circle for the k th Frame

In steps 109, 110, since all three radars 11,12,13 may be located together and assuming that the distance from the sensor suite to the moving vehicle 10 may be much larger than the distance between radars 11,12,13, the following Doppler differences may be

$$\begin{matrix}Δ {f}_{{D}_{k}}^{13} = \frac{{f}_{{D}_{k}}^{1}}{{K}_{1}} - \frac{{f}_{{D}_{k}}^{3}}{{K}_{3}} = {v}_{{r}_{1 k}} cos ( {θ}_{{r}_{1 k}} ) \\ and & ( 7 ) \\ Δ {f}_{{D}_{k}}^{23} = \frac{{f}_{{D}_{k}}^{2}}{{K}_{2}} - \frac{{f}_{{D}_{k}}^{3}}{{K}_{3}} = {v}_{{r}_{2 k}} cos ( {θ}_{{r}_{2 k}} ) & ( 8 )\end{matrix}$$

where the impact of the moving vehicle may have been removed. Eqs. (7) and (8) may actually recover the substantially independent motion Doppler signals of the first and second moving Doppler radars 11, 12, except for the conversion constants. The Doppler differences in Eqs. (7) and (8) are the ones for the kth frame.

From Eqs. (7) and (8), since νᵣ_{₁ₖ} and νᵣ_{₂ₖ} are known from calibration, Doppler cone angles at t=k may be calculated as

$$\begin{matrix}{\hat{θ}}_{{r}_{1 k}} = {cos}^{- 1} ( \frac{Δ {f}_{{D}_{k}}^{13}}{{v}_{{r}_{1 k}}} ) \\ and & ( 9 ) \\ {\hat{θ}}_{{r}_{2 k}} = {cos}^{- 1} ( \frac{Δ {f}_{{D}_{k}}^{23}}{{v}_{{r}_{2 k}}} ) . & ( 10 )\end{matrix}$$

Using Doppler cone angles in Eqs. (9) and (10), Doppler circles¹ may be constructed on the virtual image plane 3, as shown in FIG. 5. The intersections of the Doppler circles specified by \hat{θ}ᵣ_{₁ₖ} and \hat{θ}ᵣ_{₂ₖ} may effectively locate the vehicle q on the image plane, as shown in FIG. 5. The ghost intersection point, q′, may be easily removed with some physical constraints. Doppler differences, cone angles and circles defined by Eqs. (7), (8), (9) and (10) may be obtained at (k+1)th and (k+2)th frames, as in steps 116, 117, 123, and 124. ¹ Precisely speaking, these may be ellipses. Due to a small angle between radar motion vectors, the ellipses may be well approximated as circles.

4. Calculate 3D Lines from Doppler Radar to Vehicle

In step 111, assume the vehicle location is Xₜ_{ₖ}=[xₜ,yₜ,zₜ]ₖ and moving Doppler motion vectors are νᵣ_{₁ₖ}=[νᵣ_{₁ₓ},νᵣ_{_{1y}},νᵣ_{_{1z}}]ₖ and νᵣ_{₂ₖ}=[νᵣ_{₂ₓ},νᵣ_{_{2y}},νᵣ_{_{2z}}]ₖ. At t=k, we may have

$$\begin{matrix}{θ}_{{r}_{1 k}} = {cos}^{- 1} \frac{{\underline{X}}_{{t}_{k}} \cdot {\underline{v}}_{{r}_{1 k}}}{‖ {\underline{X}}_{{t}_{k}} ‖ ‖ {\underline{v}}_{{r}_{1 k}} ‖} \\ and & ( 9 ) \\ {θ}_{{r}_{2 k}} = {cos}^{- 1} \frac{{\underline{X}}_{{t}_{k}} \cdot {\underline{v}}_{{r}_{2 k}}}{‖ {\underline{X}}_{{t}_{k}} ‖ ‖ {\underline{v}}_{{r}_{2 k}} ‖} . & ( 10 )\end{matrix}$$

The Doppler differences may then be calculated as

$$\begin{matrix}\begin{matrix}Δ {f}_{{D}_{k}}^{13} = {v}_{{r}_{1 k}} cos ( {θ}_{{r}_{1 k}} ) \\ = \frac{{\underline{X}}_{{t}_{k}} \cdot {\underline{v}}_{{r}_{1 k}}}{‖ {\underline{X}}_{{t}_{k}} ‖} \\ = \frac{{v}_{{r}_{1 xk }} {x}_{{t}_{k}} + {v}_{{r}_{1 yk}} {y}_{{t}_{k}} + {v}_{{r}_{1 zk}} {z}_{{t}_{k}}}{\sqrt{{x}_{{t}_{k}}^{2} + {y}_{{t}_{k}}^{2} + {z}_{{t}_{k}}^{2}}}\end{matrix} \\ and & \begin{matrix}( 11 ) \\ ( 12 ) \\ ( 13 )\end{matrix} \\ \begin{matrix}Δ {f}_{{D}_{k}}^{23} = {v}_{{r}_{2 k}} cos ( {θ}_{{r}_{2 k}} ) \\ = \frac{{v}_{{r}_{2 xk }} {x}_{{t}_{k}} + {v}_{{r}_{2 yk}} {y}_{{t}_{k}} + {v}_{{r}_{2 zk}} {z}_{{t}_{k}}}{\sqrt{{x}_{{t}_{k}}^{2} + {y}_{{t}_{k}}^{2} + {z}_{{t}_{k}}^{2}}} .\end{matrix} & \begin{matrix}( 14 ) \\ ( 15 )\end{matrix}\end{matrix}$$

Eqs. (13) and (15) may describe two cones with central axes being OC₁ and OC₂, where O is the joint of the two cone tips. The ratio of Doppler differences may define a 3D line passing though O, qₖ and Xₜ_{ₖ}

$$\frac{Δ {f}_{{D}_{k}}^{13}}{Δ {f}_{{D}_{k}}^{23}} = \frac{{v}_{{r}_{1 xk }} {x}_{{t}_{k}} + {v}_{{r}_{1 yk}} {y}_{{t}_{k}} + {v}_{{r}_{1 zk}} {z}_{{t}_{k}}}{{v}_{{r}_{2 xk }} {x}_{{t}_{k}} + {v}_{{r}_{2 yk}} {y}_{{t}_{k}} + {v}_{{r}_{2 zk}} {z}_{{t}_{k}}} . \qquad ( 16 )$$

At t=k+1 and t=k+2, the ratios of Doppler differences may become, as in steps 118 and 125,

$$\begin{matrix}\frac{Δ {f}_{{D}_{( k + 1 )}}^{13}}{Δ {f}_{{D}_{( k + 1 )}}^{23}} = \frac{{v}_{{r}_{1 x ( k + 1 ) }} {x}_{{t}_{( k + 1 )}} + {v}_{{r}_{1 y ( k + 1 )}} {y}_{{t}_{( k + 1 )}} + {v}_{{r}_{1 z ( k + 1 )}} {z}_{{t}_{( k + 1 )}}}{{v}_{{r}_{2 x ( k + 1 ) }} {x}_{{t}_{( k + 1 )}} + {v}_{{r}_{2 y ( k + 1 )}} {y}_{{t}_{( k + 1 )}} + {v}_{{r}_{2 z ( k + 1 )}} {z}_{{t}_{( k + 1 )}}} \\ and & ( 17 ) \\ \frac{Δ {f}_{{D}_{( k + 2 )}}^{13}}{Δ {f}_{{D}_{( k + 2 )}}^{23}} = \frac{{v}_{{r}_{1 x ( k + 2 ) }} {x}_{{t}_{( k + 2 )}} + {v}_{{r}_{1 y ( k + 2 )}} {y}_{{t}_{( k + 2 )}} + {v}_{{r}_{1 z ( k + 2 )}} {z}_{{t}_{( k + 2 )}}}{{v}_{{r}_{2 x ( k + 2 ) }} {x}_{{t}_{( k + 2 )}} + {v}_{{r}_{2 y ( k + 2 )}} {y}_{{t}_{( k + 2 )}} + {v}_{{r}_{2 z ( k + 2 )}} {z}_{{t}_{( k + 2 )}}} & ( 18 )\end{matrix}$$

which may describe two more 3D lines passing through O, qₖ₊₁ and Xₜ_{ₖ₊₁}, and O, qₖ₊₂ and Xₜ_{_{k−2}}.

5. Target Kinematic and Measurement Modeling

We may need to connect three frames positional information together. In steps 104 and 108, let's consider a deterministic modeling case first. Assume the vehicle kinematics satisfy a constant velocity (CV) model

or

$$\begin{matrix}{[ \begin{matrix}\underline{X} \\ \underline{\dot{X}}\end{matrix} ]}_{k + 1} = {[ \begin{matrix}I & T \\ 0 & I\end{matrix} ] [ \begin{matrix}\underline{X} \\ \underline{\dot{X}}\end{matrix} ]}_{k} & ( 19 ) \\ {x}_{{t}_{( k + 1 )}} = {x}_{{t}_{k}} + T {\dot{x}}_{{t}_{k}} & ( 20 ) \\ {y}_{{t}_{( k + 1 )}} = {y}_{{t}_{k}} + T {\dot{y}}_{{t}_{k}} & ( 21 ) \\ {z}_{{t}_{( k + 1 )}} = {z}_{{t}_{k}} + T {\dot{z}}_{{t}_{k}} & ( 22 ) \\ {\dot{x}}_{{t}_{( k + 1 )}} = {\dot{x}}_{{t}_{k}} & ( 23 ) \\ {\dot{y}}_{{t}_{( k + 1 )}} = {\dot{y}}_{{t}_{k}} & ( 24 ) \\ {\dot{z}}_{{t}_{( k + 1 )}} = {\dot{z}}_{{t}_{k}} & ( 25 ) \\ {x}_{{t}_{( k + 2 )}} = {x}_{{t}_{k}} + 2 T {\dot{x}}_{{t}_{k}} & ( 26 ) \\ {y}_{{t}_{( k + 2 )}} = {y}_{{t}_{k}} + 2 T {\dot{y}}_{{t}_{k}} & ( 27 ) \\ {z}_{{t}_{( k + 2 )}} = {z}_{{t}_{k}} + 2 T {\dot{z}}_{{t}_{k}} & ( 28 ) \\ {\dot{x}}_{{t}_{( k + 2 )}} = {\dot{x}}_{{t}_{k}} & ( 29 ) \\ {\dot{y}}_{{t}_{( k + 2 )}} = {\dot{y}}_{{t}_{k}} & ( 30 ) \\ {\dot{z}}_{{t}_{( k + 2 )}} = {\dot{z}}_{{t}_{k}} . & ( 31 )\end{matrix}$$

So, if we know \dot{x}ₜ_{ₖ}, \dot{y}ₜ_{ₖ} and żₜ_{ₖ}, we may easily connect three frame information. The fixed Doppler radar may provide the vehicle velocity magnitude information, and we may know the LOS direction angles from the moving Doppler radars. Assume that the vectors from O to qₖ, qₖ₊₁ and qₖ₊₂ are Oqₖ=[uₖ,vₖ,f], Oqₖ₊₁=[uₖ₋₁,vₖ₊₁,f], and Oqₖ₊₂=[uₖ₋₂,vₖ₊₂,f] where f is the focal length. The fixed Doppler radar measurement at t=k may be

$$\begin{matrix}{f}_{{D}_{k}}^{3} = {K}_{3} {v}_{{t}_{k}} \frac{- {\underline{Oq}}_{k} \cdot {\underline{\dot{X}}}_{k}}{‖ {\underline{Oq}}_{k} ‖ ‖ {\underline{\dot{X}}}_{k} ‖} \\ = {K}_{3} \frac{- {\underline{Oq}}_{k} \cdot {\underline{\dot{X}}}_{k}}{‖ {\underline{Oq}}_{k} ‖} \\ = {K}_{3} \frac{{u}_{k} {\dot{x}}_{{t}_{k}} + {v}_{k} {\dot{y}}_{{t}_{k}} + f {\dot{z}}_{{t}_{k}}}{\sqrt{{u}_{k}^{2} + {v}_{k}^{2} + {f}^{2}}} .\end{matrix} \qquad \begin{matrix}( 32 ) \\ \\ \\ ( 33 ) \\ \\ ( 34 ) \\ ( 34 ) \\ ( 34 )\end{matrix}$$

At t=k+1 and t=k+2 moments, we may have

$$\begin{matrix}\begin{matrix}{f}_{{D}_{k + 1}}^{3} = {K}_{3} \frac{{u}_{k + 1} {\dot{x}}_{{t}_{k + 1}} + {v}_{k + 1} {\dot{y}}_{{t}_{k + 1}} + f {\dot{z}}_{{t}_{k + 1}}}{\sqrt{{u}_{k + 1}^{2} + {v}_{k + 1}^{2} + {f}^{2}}} \\ = {K}_{3} \frac{{u}_{k + 1} {\dot{x}}_{{t}_{k}} + {v}_{k + 1} {\dot{y}}_{{t}_{k}} + f \dot{{z}_{{t}_{k}}}}{\sqrt{{u}_{k + 1}^{2} + {v}_{k + 1}^{2} + {f}^{2}}}\end{matrix} \\ and & \begin{matrix}( 35 ) \\ \\ \\ ( 36 ) \\ \end{matrix} \\ \begin{matrix}{f}_{{D}_{k + 2}}^{3} = {K}_{3} \frac{{u}_{k + 2} {\dot{x}}_{{t}_{k + 2}} + {v}_{k + 2} {\dot{y}}_{{t}_{k + 2}} + f {\dot{z}}_{{t}_{k + 2}}}{\sqrt{{u}_{k + 2}^{2} + {v}_{k + 2}^{2} + {f}^{2}}} \\ = {K}_{3} \frac{{u}_{k + 2} {\dot{x}}_{{t}_{k}} + {v}_{k + 2} {\dot{y}}_{{t}_{k}} + f {\dot{z}}_{{t}_{k}}}{\sqrt{{u}_{k + 2}^{2} + {v}_{k + 2}^{2} + {f}^{2}}}\end{matrix} & \begin{matrix}( 37 ) \\ \\ \\ ( 38 ) \\ \end{matrix}\end{matrix}$$

Eqs. (17) and (18) are rewritten as

$$\begin{matrix}\frac{{f}_{{D}_{( k + 1 )}}^{13}}{{f}_{{D}_{( k + 1 )}}^{23}} = \frac{\begin{matrix}{v}_{{r}_{1 x ( k + 1 ) }} ( {x}_{{t}_{k}} + T {\dot{x}}_{{t}_{k}} ) + \\ {v}_{{r}_{1 y ( k + 1 )}} ( {y}_{{t}_{k}} + T {\dot{y}}_{{t}_{k}} ) + {v}_{{r}_{1 z ( k + 1 )}} ( {z}_{{t}_{k}} + T {\dot{z}}_{{t}_{k}} )\end{matrix}}{\begin{matrix}{v}_{{r}_{2 x ( k + 1 ) }} ( {x}_{{t}_{k}} + T {o}_{.} {tx}_{{ }_{{t}_{k}}} ) + \\ {v}_{{r}_{2 y ( k + 1 )}} ( {y}_{{t}_{k}} + T {\dot{y}}_{{ }_{{t}_{k}}} ) + {v}_{{r}_{2 z ( k + 1 )}} ( {z}_{{t}_{k}} + T {\dot{z}}_{{ }_{{t}_{k}}} )\end{matrix}} \\ and & ( 39 ) \\ \frac{{f}_{{D}_{( k + 2 )}}^{13}}{{f}_{{D}_{( k + 2 )}}^{23}} = \frac{\begin{matrix}{v}_{{r}_{1 x ( k + 2 ) }} ( {x}_{{t}_{k}} + 2 T {\dot{x}}_{{t}_{k}} ) + \\ {v}_{{r}_{1 y ( k + 2 )}} ( {y}_{{t}_{k}} + 2 T {\dot{y}}_{{t}_{k}} ) + {v}_{{r}_{1 z ( k + 2 )}} ( {z}_{{t}_{k}} + 2 T {\dot{z}}_{{t}_{k}} )\end{matrix}}{\begin{matrix}{v}_{{r}_{2 x ( k + 2 ) }} ( {x}_{{t}_{k}} + 2 T {\dot{x}}_{{ }_{{t}_{k}}} ) + \\ {v}_{{r}_{2 y ( k + 2 )}} ( {y}_{{t}_{k}} + 2 T {\dot{y}}_{{ }_{{t}_{k}}} ) + {v}_{{r}_{2 z ( k + 2 )}} ( {z}_{{t}_{k}} + 2 T {\dot{z}}_{{ }_{{t}_{k}}} )\end{matrix}} & ( 40 )\end{matrix}$$

Solving Eqs. (16), (34), (36), (38), (39) and (40) simultaneously may give us the positional and velocity information, [xₜ_{ₖ},yₜ_{ₖ},zₜ_{ₖ},\dot{x}ₜ_{ₖ},\dot{y}ₜ_{ₖ}, żₜ_{ₖ}], completely with the constraint of Eq. (19). Theoretically, we may calculate the velocity of a target with any heading angle, φ!

We now consider a stochastic modeling case. Assume the vehicle kinematics satisfy a stochastic CV model

$${[ \frac{\underline{X}}{\dot{\underline{X}}} ]}_{k + 1} = {[ \begin{matrix}I & I T \\ 0 & I\end{matrix} ] [ \frac{\underline{X}}{\dot{\underline{X}}} ]}_{k} + [ \begin{matrix}\frac{1}{2} I {T}^{2} \\ I\end{matrix} ] {\underline{ρ}}_{k} , {\underline{ρ}}_{k} • N ( \underline{0} , {Q}_{k} ) . \qquad ( 41 )$$

From Eq. (16), the positional measurement equation may be

$$\begin{matrix}\begin{matrix}0 = ( \frac{Δ {f}_{{D}_{k}}^{13}}{Δ {f}_{{D}_{k}}^{23}} {v}_{{r}_{2 xk}} - {v}_{{r}_{1 xk}} ) {x}_{{t}_{k}} + ( \frac{Δ {f}_{{D}_{k}}^{13}}{Δ {f}_{{D}_{k}}^{23}} {v}_{{r}_{2 yk}} - {v}_{{r}_{1 yk}} ) {y}_{{t}_{k}} + \\ ( \frac{Δ {f}_{{D}_{k}}^{13}}{Δ {f}_{{D}_{k}}^{23}} {v}_{{r}_{2 zk}} - {v}_{{r}_{1 zk}} ) {z}_{{t}_{k}} \\ = [ \frac{Δ {f}_{{D}_{k}}^{13}}{Δ {f}_{{D}_{k}}^{23}} {v}_{{r}_{2 xk}} - {v}_{{r}_{1 xk}} , \frac{Δ {f}_{{D}_{k}}^{13}}{Δ {f}_{{D}_{k}}^{23}} {v}_{{r}_{2 xk}} - {v}_{{r}_{1 xk}} , \frac{Δ {f}_{{D}_{k}}^{13}}{Δ {f}_{{D}_{k}}^{23}} {v}_{{r}_{2 xk}} - {v}_{{r}_{1 xk}} ] \\ {\underline{X}}_{k} + {\underline{γ}}_{{x}_{k}} ,\end{matrix} & ( 42 ) \\ {\underline{γ}}_{{x}_{k}} • N ( \underline{0} , {R}_{{x}_{k}} ) . & ( 43 )\end{matrix}$$

The velocity measurement equation may be established from Eq. (34) as

$$\begin{matrix}\begin{matrix}{f}_{{D}_{k}}^{3} = {\overline{u}}_{k} {\dot{x}}_{{t}_{k}} + {\overline{v}}_{k} {\dot{y}}_{{t}_{k}} + \overline{f} {\dot{z}}_{{t}_{k}} + {\underline{γ}}_{{\dot{x}}_{k}} \\ = [ {\overline{u}}_{k} , {\overline{v}}_{k} , \overline{f} ] {\dot{\underline{X}}}_{k} + {\underline{γ}}_{{\dot{x}}_{k}}\end{matrix} \\ where & \begin{matrix}( 44 ) \\ ( 45 )\end{matrix} \\ {\overline{u}}_{k} = {K}_{3} \frac{{u}_{k}}{\sqrt{{u}_{k}^{2} + {v}_{k}^{2} + {f}^{2}}} , \\ {\overline{v}}_{k} = {K}_{3} \frac{{v}_{k}}{\sqrt{{u}_{k}^{2} + {v}_{k}^{2} + {f}^{2}}} and \\ \overline{f} = {K}_{3} \frac{f}{\sqrt{{u}_{k}^{2} + {v}_{k}^{2} + {f}^{2}}} . & ( 46 )\end{matrix}$$

Eqs. (41), (43) and (45) may form a stochastic system for the vehicle and a Kalman filter may be used to estimate the position and velocity of the vehicle. Minimum three scans may be needed to converge.

We claim:

1. A system of estimating a moving vehicle velocity, comprising:
a. generating said moving vehicle location on an image plane,
b. generating said moving vehicle location on a 3D line in a 3D reference coordinate,
c. generating a speed measurement of said moving vehicle, and
d. generating an estimate of said velocity of said vehicle,
whereby said method will estimate said vehicle velocity.

2. A system of estimating a moving vehicle velocity as recited in claim 1, wherein the method generates said vehicle location on said image plane by intersecting two Doppler circles.

3. A system of estimating a moving vehicle velocity as recited in claim 2, wherein the method generates said Doppler circles from Doppler differences.

4. A system of estimating a moving vehicle velocity as recited in claim 2, wherein the method generates said Doppler differences from a movable Doppler radar and a fixed Doppler radar.

5. A system of estimating a moving vehicle velocity as recited in claim 1, wherein the method generates said 3D location of said vehicle in a 3D reference coordinate by linking said vehicle locations on three 3D lines.

6. A system of estimating a moving vehicle velocity as recited in claim 5, wherein the method generates said 3D line by passing a 3D line through said Doppler circle intersection and a join of Doppler cone tips.

7. A system of estimating a moving vehicle velocity as recited in claim 5, wherein the method generates said Doppler cone from a Doppler angle.

8. A system of estimating a moving vehicle velocity as recited in claim 5, wherein the method generates said Doppler angle from Doppler radar signals.

9. A system of estimating a moving vehicle velocity as recited in claim 1, wherein the method generates said speed measurement of said moving vehicle from said fixed Doppler radar.

10. A system of estimating a moving vehicle velocity as recited in claim 1, wherein the method generates said velocity estimate of said moving vehicle by an estimator.

11. A system of estimating a moving vehicle velocity as recited in claim 10, wherein said estimator uses at least one vehicle model and one measurement model.

12. A system of estimating a moving vehicle velocity as recited in claim 1, wherein the method uses at least one movable Doppler radar, at least one fixed Doppler radar, and at least one video camera.

13. A system of estimating a moving vehicle velocity as recited in claim 1, wherein the method uses at least data processing device and at least one data recording device.
